(19) United States
(12) Patent Application Publication
(10) Pub. No.: US 2008/0141464 A1
(43) Pub. Date: Jun. 19, 2008

(54) TOOL PARTS FOR POCKET MULTITOOL

(76) Inventor: Dov Pikielny, Herzliya (IL)

Correspondence Address: DEKEL PATENT LTD., DAVID KLEIN, BEIT HAROF'IM, 18 MENUHA VENAHALA STREET, ROOM 27, REHOVOT, 76209, omitted

(21) Appl. No.: 11/556,711

(22) Filed: Dec. 19, 2006

(51) Int. Cl. B26B 11/00

(52) U.S. Cl. 7/118; 7/158

(57) ABSTRACT

A pocket multitool that includes a knife and non-knife tools, and a set of interchangeable replacement parts for at least one of the knife and non-knife tools, wherein at least one of the interchangeable replacement parts may include a tool face with a different hardness than at least one of the knife and non-knife tools.

### FIELD OF THE INVENTION

The present invention relates generally to pocket multitools, and particularly to tool parts for pocket multitools, such as ceramic tool parts or parts with different hardnesses.

### BACKGROUND OF THE INVENTION

Many pocket multitools are known and commercially available. These multitools may include various tools, such as a knife blade and screwdriver bits that pivot in and out of handles of the tool. Some multitools include jaws of pliers and various cutting tools or scissors. The various tools and cutting parts are generally made of hardened steel.

### SUMMARY OF THE INVENTION

The present invention seeks to provide an improved pocket multitool and tool parts for pocket multitools, such as ceramic tool parts or parts with different hardnesses, as is described in detail further hereinbelow.

There is thus provided in accordance with an embodiment of the present invention a pocket multitool that includes a knife and non-knife tools, wherein at least one of the non-knife tools includes a ceramic tool part.

The pocket multitool can include one or more of the following features. For example, the knife may include a ceramic knife edge. One or more of the non-knife tools may include a ceramic jaw of pliers. One or more of the non-knife tools may include a ceramic blade of a cutting pliers or ceramic scissors, for example.

There is also provided in accordance with an embodiment of the present invention a pocket multitool that includes a knife and non-knife tools, and a set of interchangeable replacement parts for at least one of the knife and non-knife tools, wherein at least one of the interchangeable replacement parts may include a tool face with a different hardness than at least one of the knife and non-knife tools.

For example, one or more of the interchangeable replacement parts may include a tool face with a different hardness than another of the interchangeable replacement parts. One of the interchangeable replacement parts may include a ceramic knife edge, ceramic jaw of pliers, ceramic blade of cutting pliers or ceramic scissors, for example. As another example, one or more of the interchangeable replacement parts may include an elastomeric jaw of pliers. The interchangeable replacement part may include a receptacle with an aperture, wherein the knife or non-knife tool is adapted to be placed through the aperture into the receptacle.

There is also provided in accordance with an embodiment of the present invention a method including providing a set of interchangeable replacement parts for a pocket multitool that includes a knife and non-knife tools, wherein at least one of the interchangeable replacement parts includes a tool face with a different hardness than at least one of the knife and non-knife tools. The method may further include replacing at least one of the knife and non-knife tools with at least one of the interchangeable replacement parts.

### BRIEF DESCRIPTION OF THE DRAWINGS

The present invention will be understood and appreciated more fully from the following detailed description taken in conjunction with the drawings in which:

FIG. 1 is a simplified pictorial illustration of a pocket multitool, constructed and operative in accordance with an embodiment of the present invention;

FIGS. 2 and 3 are simplified illustrations of tool parts for the pocket multitool of FIG. 1, in accordance with embodiments of the present invention; and

FIGS. 4, 5 and 6 are simplified illustrations of tool parts for the pocket multitool of FIG. 1, in accordance with other embodiments of the present invention.

### DETAILED DESCRIPTION OF EMBODIMENTS

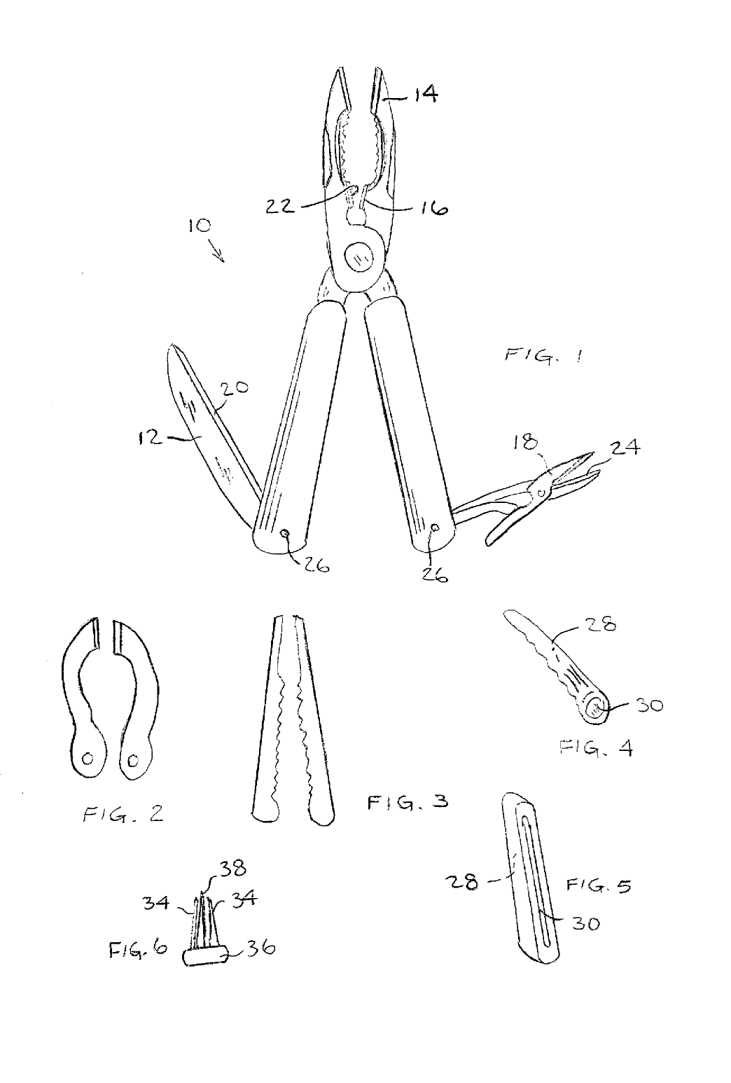

Reference is now made to FIG. 1, which illustrates a pocket multitool 10, constructed and operative in accordance with an embodiment of the present invention.

The pocket multitool 10 may include one or more knives 12 and non-knife tools, such as but not limited to, pliers jaws 14, cutting pliers 16 and scissors 18. In accordance with an embodiment of the present invention, one or more of the non-knife tools may include a tool part that is made of a hard or hardened non-metal, such as a ceramic tool part. In addition, the knife 12 may include a ceramic knife edge 20. For example, the pliers jaws 14 may be constructed of ceramics (e.g., the gripping part of the jaws may be ceramic). The cutting pliers 16 may have ceramic blades 22. The scissors 18 may have ceramic blades 24. Throughout the specification and claims, the terms “ceramic” and “hard or hardened non-metal” are used interchangeably.

The ceramic tool edges/surfaces may be made of ceramic materials (e.g., sintered powder) available from a variety of manufacturers, such as Kyocera of Japan.

In accordance with another embodiment of the present invention, the pocket multitool 10 may include a set of interchangeable replacement parts for the knife 12 and/or the non-knife tools. The tool face (i.e., the part that contacts a work piece) of the interchangeable replacement parts may be used to impart a different hardness (either harder or softer) than the knife 12 or the non-knife tools. Additionally or alternatively, the set of interchangeable replacement parts may include one part with a relatively hard tool face (e.g., ceramic) and another one with a different hardness (e.g., softer, such as an elastomeric material, for example, rubber, neoprene, etc.).

FIGS. 2 and 3 illustrate two examples of interchangeable replacement parts. FIG. 2 shows a replacement pair of ceramic pliers jaws with ceramic blades of cutting pliers. The knife shown in FIG. 1 may be a replacement knife and the scissors shown in FIG. 1 may be a replacement scissors. These parts may be attached to and detached from pivots or hinges 26 in the multitool 10, for example.

Reference is now made to FIGS. 4-6. As another example of attaching/detaching the replacement part, the interchangeable replacement part may include a receptacle 28 with an aperture 30. Such an embodiment is particularly suited for an interchangeable replacement part that is made of an elastomeric material, but may also be used for hard interchangeable replacement parts. The knife or non-knife tool is adapted to be placed through the aperture 30 into the receptacle 28. In FIG. 4, the receptacle 28 is elongate and the replacement part is slipped over the tool or knife (blade). In FIG. 5, the receptacle 28 is shallow but the aperture 30 is elongate and the replacement part fits over the tool or knife (blade). In FIG. 6, a tool part may include blades 34 mounted in a holder 36 (e.g., handle or backing) and separated from one another by a gap. A replacement part blade 38 may be placed in the gap between blades 34, such as by press fitting the back or spine of blade 38 into the holder 36. The replacement blade 38 may jut beyond the edges of blade 34 and have a different hardness than blades 34.

It is appreciated that various features of the invention which are, for clarity, described in the contexts of separate embodiments, may also be provided in combination in a single embodiment. Conversely, various features of the invention which are, for brevity, described in the context of a single embodiment, may also be provided separately or in any suitable subcombination.

What is claimed is:

1. An article comprising:
a pocket multitool that comprises a knife and non-knife tools, wherein at least one of said non-knife tools comprises a ceramic tool part.

2. The article according to claim 1, wherein said knife comprises a ceramic knife edge.

3. The article according to claim 1, wherein said at least one of said non-knife tools comprises a ceramic jaw of a pliers.

4. The article according to claim 1, wherein said at least one of said non-knife tools comprises a ceramic blade of a cutting pliers.

5. The article according to claim 1, wherein said at least one of said non-knife tools comprises a ceramic scissors.

6. An article comprising:
a pocket multitool that comprises a knife and non-knife tools; and
a set of interchangeable replacement parts for at least one of said knife and non-knife tools, wherein at least one of said interchangeable replacement parts comprises a tool face with a different hardness than at least one of said knife and non-knife tools.

7. The article according to claim 6, wherein at least one of said interchangeable replacement parts comprises a tool face with a different hardness than another of said interchangeable replacement parts.

8. The article according to claim 6, wherein at least one of said interchangeable replacement parts comprises a ceramic knife edge.

9. The article according to claim 6, wherein said at least one of said interchangeable replacement parts comprises a ceramic jaw of a pliers.

10. The article according to claim 6, wherein said at least one of said interchangeable replacement parts comprises a ceramic blade of a cutting pliers.

11. The article according to claim 6, wherein said at least one of said interchangeable replacement parts comprises a ceramic scissors.

12. The article according to claim 6, wherein said at least one of said interchangeable replacement parts comprises an elastomeric jaw of a pliers.

13. The article according to claim 6, wherein said at least one of said interchangeable replacement parts comprises a receptacle with an aperture, wherein said knife or non-knife tool is adapted to be placed through said aperture into said receptacle.

14. An article comprising:
a tool that comprises a knife; and
an interchangeable replacement blade for said knife comprising a receptacle and an aperture, wherein a blade of said knife is receivable in said receptacle through said aperture.

15. The article according to claim 14, wherein said interchangeable replacement blade is harder than said blade of said knife.

16. The article according to claim 14, wherein said interchangeable replacement blade comprises a ceramic blade.

17. The article according to claim 14, wherein said receptacle is elongate and said interchangeable replacement blade is slipped over said blade of said knife.

18. The article according to claim 14, wherein said interchangeable replacement blade is mounted in a holder in a gap between a plurality of knife blades.
